(19) United States
(12) Patent Application Publication
(10) Pub. No.: US 2010/0262679 A1
(43) Pub. Date: Oct. 14, 2010

(54) METHOD AND SYSTEM FOR CHECKING AUTOMATICALLY CONNECTIVITY STATUS OF AN IP LINK ON IP NETWORK

(76) Inventor: Jim Liu, Shanghai (CN)

Correspondence Address: FAY SHARPE/LUCENT, 1228 Euclid Avenue, 5th Floor, The Halle Building, Cleveland, OH, 44115-1843, US

(21) Appl. No.: 12/676,020

(22) PCT Filed: Sep. 3, 2007
(86) PCT No.: PCT/CN07/02633

§ 371 Date: Jun. 25, 2010

(51) Int. Cl. G06F 15/177; G06F 15/173

(52) U.S. Cl. 709/220; 709/224

(57) ABSTRACT

The invention provides a method and a system for method for checking automatically connectivity status of an IP link on IP network. The method for checking automatically connectivity status of an IP link on IP network comprises: sending automatically Ping request through the IP link at a dynamic auto ping rate.

### TECHNICAL FIELD OF THE INVENTION

The present invention relates to networking technology, in particular, to a method and system for checking automatically connectivity status of an IP link on IP network.

### BACKGROUND OF THE INVENTION

To maintain a connectivity status of IP links on IP network is a core part of all existing IP related products including Telecommunication network IP access interfaces. The connectivity of an IP link is mostly done by auto Ping (ICMP (Internet Control Message Protocol) request & response).

Specifically, the Ping utility is a system tool that is used to see if a computer is operating and also to see if the IP link to the computer is working well. Ping uses the ICMP Echo function. That is, Ping uses the ICMP protocol's ECHO_REQUEST datagram to elicit an ICMP ECHO_RESPONSE from the target computer. A small packet is sent through the IP link to the particular IP address of the target computer. The computer that sent the packet then waits (or “listens”) for a return packet. If the IP link is good and the target computer is up, a good return packet will be received. Ping can also tell the user the amount of time it takes for the packet to get to the target computer and back again. If this takes an extended period of time, it is indicated that something may be wrong.

In general, if a Ping request has no response back at all, the connectivity of that IP link will be down, so no service can be run on that IP link.

Therefore, in order to provide correctly services through an IP link, the connectivity status of the IP link must be updated in real time. This is done by auto Ping. However, in order to do that, some vendors set the rate of auto Ping very high (i.e. one ping every 20 milliseconds). In this case, the far end might consider this frequent incoming Ping is some illegal DoS (Denial of Service) attack, so might block all the services on this IP link.

Currently, the rate of auto Ping can be changed manually to find the balance of timely updating connectivity status of an IP link and not consuming far end too much system resource to acknowledge back.

However, if the rate of auto Ping is too low, the connectivity status of the IP link couldn't be updated timely.

On the other hand, if the rate of auto Ping is too high, the far end will consume too much resource and could possibly consider it as a DoS attack and turn off all services.

### SUMMARY OF THE INVENTION

The present invention is proposed to resolve the above problem in the prior art, the object of which is to provide a method and system for checking automatically connectivity status of an IP link on IP network, in order to not only update the connectivity status of the IP link timely, but also consume minimum system resource of far end as well as generate minimum traffic to the IP network.

According to one aspect of the invention, there is provided a method for checking automatically connectivity status of an IP link on IP network comprising: sending automatically Ping request through the IP link at a dynamic auto ping rate.

According to another aspect of the invention, there is provided a system for checking automatically connectivity status of an IP link on IP network, comprising: a Ping request sending unit configured to create Ping request and send it automatically through the IP link at a dynamic auto ping rate.

### BRIEF DESCRIPTION OF THE DRAWINGS

It is believed that the features, advantages and purposes of the present invention will be better understood from the following description of the detailed implementation of the present invention read in conjunction with the accompanying drawings, in which:

FIG. 1 depicts a flowchart of the method for checking automatically connectivity status of an IP link on IP network according to an embodiment of the invention;

FIG. 2 is an exemplary statistics diagram illustrating the varying of the possibility of link down of the IP link with time;

FIG. 3 depicts a schematic block diagram of the system for checking automatically connectivity status of an IP link on IP network according to an embodiment of the invention.

### DETAILED DESCRIPTION OF EMBODIMENTS OF THE INVENTION

The key concept of the present invention is that the auto ping rate, at which the Ping request is automatically sent, is set according to the following two rules:

1. set automatically different auto ping rates for different periods of time according to statistics of possibility of link down. That is, in the periods of time in which the possibility of link down is high, the auto ping rate is set to a higher value; on the other hand, in the periods of time in which the possibility of link down is low, the auto ping rate is set to a lower value.

2. set the auto ping rate depending on current IP link status. That is, if current IP link is UP, Ping request is sent out at a lower rate; on the other hand, if the far end doesn't response, that is, if the IP link is down, Ping request is sent out at a higher rate until the link is UP again.

Next, a detailed description of preferred embodiments of the present invention will be given with reference to the drawings.

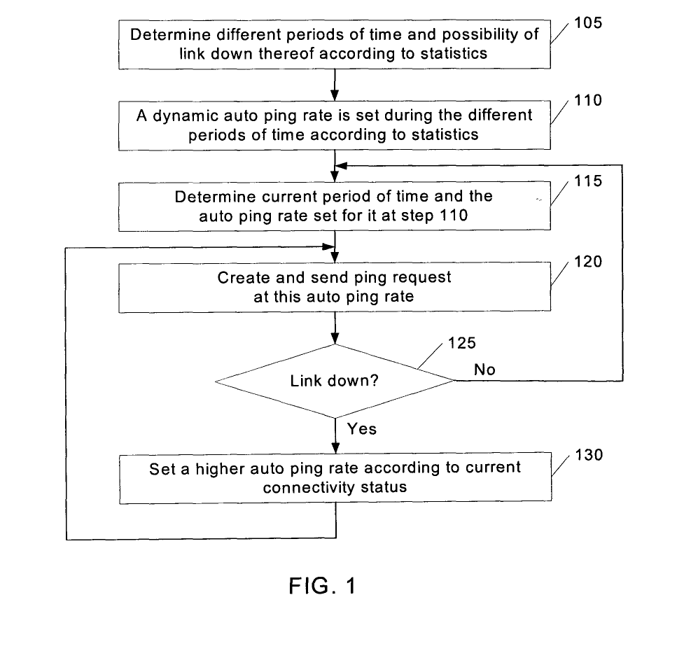

FIG. 1 depicts a flowchart of the method for checking automatically connectivity status of an IP link on IP network according to an embodiment of the invention.

As shown in FIG. 1, firstly, at step 105, the periods of time of which the possibilities of link down of the IP link are different with each other, are determined according to statistics.

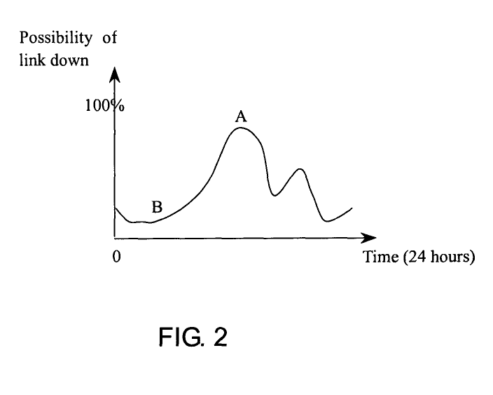

FIG. 2 is an exemplary statistics diagram illustrating the varying of the possibility of link down of the IP link with time. As can be seen from FIG. 2, the possibility of link down of the IP link varies with time during 24 hours, i.e. one day. The peak of it occurs on working hours during which the IP network is usually heavily used, and at other time, the possibility is relatively low. For example, on point A, the possibility of link down is very high, however, on point B, the possibility of link down is low.

Therefore, at this step, one day is divided into a plurality of periods of time of which the possibilities of link down of the IP link are different with each other according to the statistics of possibility of link down of the IP link like that of FIG. 2.

Next, at step 110, a dynamic auto ping rate is set during the different periods of time according to the statistics of possibility of link down. That is, for the plurality of different periods of time, different auto ping rates are set according to the statistics of possibility of link down.

Specifically, at this step, for each of the different periods of time determined at step 105, an auto ping rate is set according to the possibility of link down in the period of time determined from the statistics like that of FIG. 2. That is, if the possibility of link down of the IP link is high in the period of time according to the statistics, a higher auto ping rates will be set for it, however, if the possibility of link down of the IP link is low in the period of time according to the statistics, a lower auto ping rate will be set for it.

For example, according to the statistics of possibility of link down of FIG. 2, on point A, the possibility of link down is very high, so the auto ping rate of the period of time containing the point A, is set to a higher value. However, on point B, the possibility of link down is low, so the auto ping rate of the period of time containing the point B, is set to a lower value.

That is, at this step, according to the statistics of possibility of link down of the IP link, higher auto ping rates are set respectively for the periods of time in which the possibility of link down of the IP link is high; on the other hand, lower auto ping rates are set respectively for the periods of time in which the possibility of link down of the IP link is low.

Then, at step 115, during the current checking process, the current period of time and the auto ping rate set for it at step 110 are determined.

At step 120, Ping request is created and sent automatically through the IP link at the determined auto ping rate.

At step 125, during the period of time, the current connectivity status of the IP link is determined based on the previous sending of Ping request.

Specifically, at this step, it is determined if the IP link is down, that is, if the far end of the IP link doesn't response the Ping request sent previously. If so, it is indicated that the IP link is down, so the process proceeds to step 130 to reset the auto ping rate, otherwise, returns to step 115 to send Ping request at the current auto ping rate continuously without changing the current auto ping rate.

At step 130, the auto ping rate is dynamically set to a higher value according to current connectivity status of the IP link. That is, in the present embodiment, besides the statistics of possibility of link down of the IP link, the auto ping rate is also dynamically set depending on current connectivity status of the IP link.

Therefore, at this step, due to that the IP link is down according to the determination at step 125, a higher auto ping rate is set in order to send subsequently out Ping request at the higher rate until the IP link is UP again. And then, the process returns to step 120 to create and send Ping request at the higher auto ping rate set newly at this step 130.

In addition, in the above embodiment, although the auto ping rate is unchanged if the IP link is not down, that is, it is normally working, according to the determination at step 125, this is only illustrative. It also can be that, when it is determined that the IP link is normally working in current period of time at step 125, the auto ping rate of the current period of time determined at step 115 is adjusted to a lower value according to the possibility of link down in the current period of time and the current connectivity status of the IP link, in order to combine the above two rules to find a best auto ping rate for the current period of time.

In addition, it is noted that, the auto ping rate is set according to both the statistics of possibility of link down and the current connectivity status of the IP link in the above embodiment, however, the present invention is not limited to this. In other embodiments, it is also can be that the auto ping rate is set according to only the statistics of possibility of link down of the IP link or only the current connectivity status of the IP link.

Specifically, in the case that the auto ping rate is set according to only the statistics of possibility of link down of the IP link, higher auto ping rates will be set respectively for the periods of time in which the possibility of link down of the IP link is high, and lower auto ping rates will be set respectively for the periods of time in which the possibility of link down of the IP link is low.

On the other hand, in the case that the auto ping rate is set according to only the current connectivity status of the IP link, higher auto ping rates will be set respectively for the periods of time in which the IP link is down until the IP link is up again, and lower auto ping rates will be set respectively for the periods of time in which the IP link is normally working.

The above is a description of the method for checking automatically connectivity status of an IP link on IP network according to an embodiment of the invention. It can be seen from the above description that, instead of sending out Ping request in same rate at anytime in any conditions, in the method according to the embodiment, the Ping request can be sent out in a dynamic auto ping rate according to the statistics of possibility of link down and the current connectivity status of the IP link to get best result but consume less resources. Specifically, by using the method, the following advantages can be achieved:
around 50% Ping traffic to the IP network can be saved, so more bandwidth can be used for signaling and bearer;
the IP interface 50% system resource of the far end of the IP link to response those ICMP requests can be saved;
“too many ICMP requests” alert won't be caused in the far end;
the Ping requests won't be considered as DoS attacks by the far end any more.

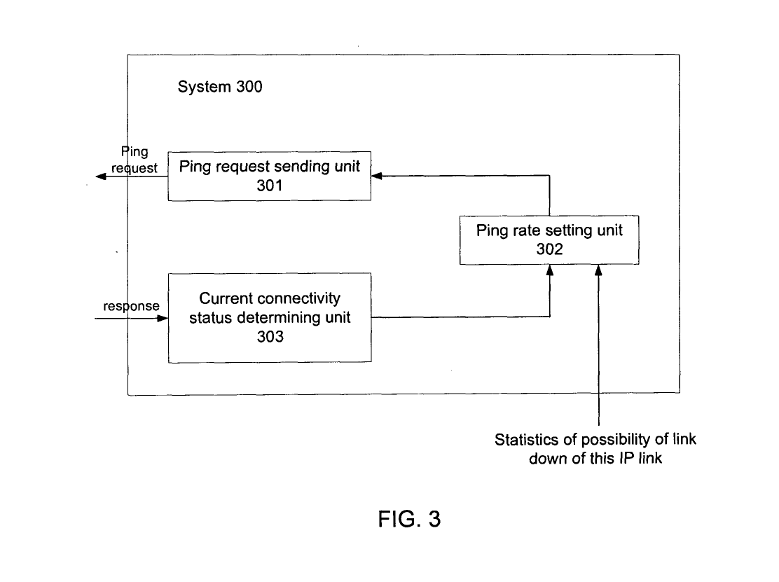

Under the same inventive conception, FIG. 3 depicts a schematic block diagram of the system for checking automatically connectivity status of an IP link on IP network according to an embodiment of the invention.

As shown in FIG. 3, the system 300 comprises: Ping request sending unit 301 configured to create Ping request and send it automatically through the IP link at a dynamic auto ping rate.

In addition, the system 300 can further comprise: ping rate setting unit 302 configured to set the dynamic auto ping rate.

In addition, the system 300 can further comprise: current connectivity status determining unit 303 configured to receive response to Ping request sent previously by the Ping request sending unit 301 from far end of the IP link and determine current connectivity status of the IP link based on previous sending of Ping request.

More specifically, the ping rate setting unit 302 sets the dynamic auto ping rate according to statistics of possibility of link down of the IP link. The statistics of possibility of link down of the IP link is like that of FIG. 2.

Specifically, the ping rate setting unit 302 determines a plurality of periods of time of which the possibilities of link down of the IP link are different with each other according to the statistics of possibility of link down of the IP link. Then, the ping rate setting unit 302, for the different periods of time, sets different auto ping rates. Specifically, the ping rate setting unit 302 sets, according to the statistics of possibility of link down of the IP link, higher auto ping rates for the periods of time in which the possibility of link down of the IP link is high, and lower auto ping rates for the periods of time in which the possibility of link down of the IP link is low.

In addition, the ping rate setting unit 302 further sets the dynamic auto ping rate according to the current connectivity status determined by the current connectivity status determining unit 303.

Specifically, in each of the different periods of time, the current connectivity status determining unit 303 receives continuously response to the Ping request sent previously by the Ping request sending unit 301 from the far end of the IP link to see if the IP link is down, that is, if the far end doesn't response the Ping request, and then determines the current connectivity status of the IP link. And then the current connectivity status determining unit 303 informs the current connectivity status of the IP link to the ping rate setting unit 302.

The ping rate setting unit 302, according to the current connectivity status of the IP link informed by the current connectivity status determining unit 303, sets a higher auto ping rate if the IP link is down.

In an alternative embodiment, the ping rate setting unit 302, according to the current connectivity status of the IP link informed by the current connectivity status determining unit 303, also adjusts the current auto ping rate to a lower value according to the possibility of link down of current period of time and the current connectivity status of the IP link if the IP link is normally working, in order to combine the above two rules to find a best auto ping rate for the current period of time.

Then, the Ping request sending unit 301 creates Ping request and sends it automatically through the IP link at the auto ping rate set by the ping rate setting unit 302.

It is noted that, the auto ping rate is set according to both the statistics of possibility of link down and the current connectivity status of the IP link in the above embodiment, however, the present invention is not limited to this.

In an alternative embodiment, the system 300 may not comprise the current connectivity status determining unit 303, and the ping rate setting unit 302 may set the dynamic auto ping rate according to only statistics of possibility of link down of the IP link. That is, the ping rate setting unit 302 sets higher auto ping rates for the periods of time in which the possibility of link down of the IP link is high, and lower auto ping rates for the periods of time in which the possibility of link down of the IP link is low according to the statistics.

In another embodiment, the ping rate setting unit 302 may set the dynamic auto ping rate according to only the current connectivity status determined by the current connectivity status determining unit 303. That is, the ping rate setting unit 302 sets, according to the current connectivity status, higher auto ping rates for the periods of time in which the IP link is down, and lower auto ping rates for the periods of time in which the IP link is normally working.

It can be appreciated that the system 300 and their components can be implemented with specifically designed circuits or chips or be implemented by a computing device (information processing device) executing corresponding programs. Moreover, the respective components of the system 300 may be physically separated but operationally cooperated.

The above is a description of the system for checking automatically connectivity status of an IP link on IP network according to an embodiment of the invention. It can be seen from the above description that, instead of sending out Ping request in same rate at anytime in any conditions, the system sends automatically out the Ping request in a dynamic auto ping rate according to the statistics of possibility of link down and the current connectivity status of the IP link to get best result but consume less resources. Specifically, by using the system, the following advantages can be achieved:
around 50% Ping traffic to the IP network can be saved, so more bandwidth can be used for signaling and bearer;
the IP interface 50% system resource of the far end of the IP link to response those ICMP requests can be saved;
“too many ICMP requests” alert won't be caused in the far end;
the Ping requests won't be considered as DoS attacks by the far end any more.

While the method and system for checking connectivity status of an IP link on IP network of the present invention have been described in detail with some exemplary embodiments, these embodiments are not exhaustive, and those skilled in the art may make various variations and modifications within the spirit and scope of the present invention. Therefore, the present invention is not limited to these embodiments, the scope of which is only defined by appended claims.

1. A method for checking automatically connectivity status of an IP link on IP network, comprising:
sending automatically Ping request through the IP link at a dynamic auto ping rate.

2. The method for checking automatically connectivity status of an IP link on IP network according to claim 1, further comprising the following step previous to the step of sending automatically Ping request through the IP link at a dynamic auto ping rate:
setting the dynamic auto ping rate.

3. The method for checking automatically connectivity status of an IP link on IP network according to claim 2, wherein the step of setting the dynamic auto ping rate further comprises:
setting the dynamic auto ping rate according to statistics of possibility of link down of the IP link.

4. The method for checking automatically connectivity status of an IP link on IP network according to claim 3, wherein the step of setting the dynamic auto ping rate according to statistics of possibility of link down of the IP link further comprises:
setting higher auto ping rates for the periods of time in which the possibility of link down of the IP link is high according to the statistics of possibility of link down of the IP link; and
setting lower auto ping rates for the periods of time in which the possibility of link down of the IP link is low according to the statistics of possibility of link down of the IP link.

5. The method for checking automatically connectivity status of an IP link on IP network according to claim 4, wherein the periods of time in which the possibility of link down of the IP link is high, are the periods of time in a day in which the IP network is heavily used; and the periods of time in which the possibility of link down of the IP link is low, are the periods of time in a day in which the IP network is infrequently used.

6. The method for checking automatically connectivity status of an IP link on IP network according to claim 2, further comprising:
determining current connectivity status of the IP link based on previous sending of Ping request.

7. The method for checking automatically connectivity status of an IP link on IP network according to claim 6, wherein the step of setting the dynamic auto ping rate further comprises:
setting the dynamic auto ping rate according to current connectivity status of the IP link.

8. The method for checking automatically connectivity status of an IP link on IP network according to claim 7, wherein the step of setting the dynamic auto ping rate according to current connectivity status of the IP link further comprises:
setting higher auto ping rates for the periods of time in which the IP link is down; and
setting lower auto ping rates for the periods of time in which the IP link is normally working.

9. The method for checking automatically connectivity status of an IP link on IP network according to claim 1, further comprising the following step previous to the step of sending automatically Ping request through the IP link at a dynamic auto ping rate:
creating automatically Ping request specific to the IP link at the dynamic auto ping rate.

10. A system for checking automatically connectivity status of an IP link on IP network, comprising:
a Ping request sending unit configured to create Ping request and send it automatically through the IP link at a dynamic auto ping rate.

11. The system for checking automatically connectivity status of an IP link on IP network according to claim 10, further comprising:
a ping rate setting unit configured to set the dynamic auto ping rate.

12. The system for checking automatically connectivity status of an IP link on IP network according to claim 11, wherein the ping rate setting unit further sets, according to statistics of possibility of link down of the IP link, higher auto ping rates for the periods of time in which the possibility of link down of the IP link is high, and lower auto ping rates for the periods of time in which the possibility of link down of the IP link is low.

13. The system for checking automatically connectivity status of an IP link on IP network according to claim 11, further comprising:
a current connectivity status determining unit configured to receive response to Ping request sent previously by the Ping request sending unit from far end of the IP link and determine current connectivity status of the IP link based on previous sending of Ping request.

14. The system for checking automatically connectivity status of an IP link on IP network according to claim 13, wherein the ping rate setting unit further sets, according to the current connectivity status determined by the current connectivity status determining unit, higher auto ping rates for the periods of time in which the IP link is down, and lower auto ping rates for the periods of time in which the IP link is normally working.
